(19) United States
(12) Patent Application Publication
(10) Pub. No.: US 2007/0202924 A1
(43) Pub. Date: Aug. 30, 2007

(54) Method and apparatus for activating features in a mobile communication system

(75) Inventors: Cheng-Shing Lai, Taipei (TW); Xiao-Long Fan, Nanking (CN); Jia-Sheng Mei, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/589,045

(22) Filed: Oct. 30, 2006

(30) Foreign Application Priority Data
Feb. 27, 2006 (TW) 095106527

(51) Int. Cl. H04B 1/38; H04M 3/42

(52) U.S. Cl. 455/566; 455/415

(57) ABSTRACT

The invention relates to a method for activating different features in a mobile communication system, by implementing at least one hot key and a plurality of features; when one or more of said at least one hot key is triggered, a special feature corresponding to the triggered hot key would be selectively activated according to the current time, hence the mobile communication systems is able to use same hot key(s) to activate different features under different time settings. The invention also relates to an apparatus for activating different features in a mobile communication system.

### FIELD OF THE INVENTION

The present invention relates to a method for activating different features in a mobile communication system and an apparatus thereof. In particular, the present invention relates to a method for activating different features in a mobile communication system according to the current time and an apparatus thereof.

### BACKGROUND OF THE INVENTION

Many commonly used mobile communication systems (e.g. cellular phones, PDAs) provide plenty of special features in different categories. For example, an address book, video games, and other programmable feature groups. Some of the features contain sub-features. In order to successfully execute a sub-feature, a user has to either memorize the program path of the sub-feature or go through a hierarchical selecting process. Those procedures are tedious and will become more and more troublesome when the provided features grow to a huge amount. Thus, to make it more convenient for users, mobile communication system manufacturers started to develop hot keys. The hot keys are short-cut keys for frequently used features or dialed phone numbers. After a hot key is defined for a desired function, a user can conveniently and promptly execute a desired function or dial a phone number without going through hierarchical selections of features.

Most mobile communication systems provide limited number of hot keys. A user has to define the same hot keys for different desired features under different circumstances. For example, a user may want to define a hot key for a calculator during regular work hours, and define the same hot key for a specific game in the evening or for rejecting phone calls at early morning. To achieve this, a user has to change the definition of a hot key at different time. It causes inconvenience and disruption. Therefore, a method for selectively activating features according to current time in a mobile communication system is highly demanded.

### SUMMARY OF THE INVENTION

After considerable research and experimentation, a method and apparatus thereof for activating features in a mobile communication system according to the present invention has been developed so as to overcome the drawbacks associated with said prior art.

It is an object of the present invention to provide a method and an apparatus thereof for activating different features in a mobile communication system, by implementing at least one hot key and a plurality of features; when one or more of said at least one hot key is triggered, a special feature corresponding to the triggered hot key would be selectively activated according to the current time, hence the mobile communication systems is able to use same hot key(s) to activate different features under different time settings. The present invention also relates to an apparatus for activating different features in a mobile communication system.

The above and other objects, features and advantages of the present invention will become apparent from the following detailed description taken with the accompanying drawings.

### BRIEF DESCRIPTION OF THE DRAWINGS

The features, objects and advantages of the invention will become more apparent from the detailed description set forth below when taken in conjunction with the drawings in which like references characters identify correspondingly throughout, and wherein:

FIG. 1 is a representative diagram showing a first preferred embodiment of a mobile communication system in accordance with the present invention.

FIG. 2 is a diagram showing a hot key list in the first preferred embodiment.

FIG. 3 is a flow chart illustrating the procedure of the first preferred embodiment.

FIG. 4 is a diagram showing a hot key setup interface in the first preferred embodiment.

FIG. 5 is a flow chart illustrating the procedure of programming a hot key in the first preferred embodiment.

FIG. 6 is a flow chart illustrating the procedure of a second preferred embodiment in accordance with the present invention.

### DETAILED DESCRIPTION OF THE PREFERRED EMBODIMENTS

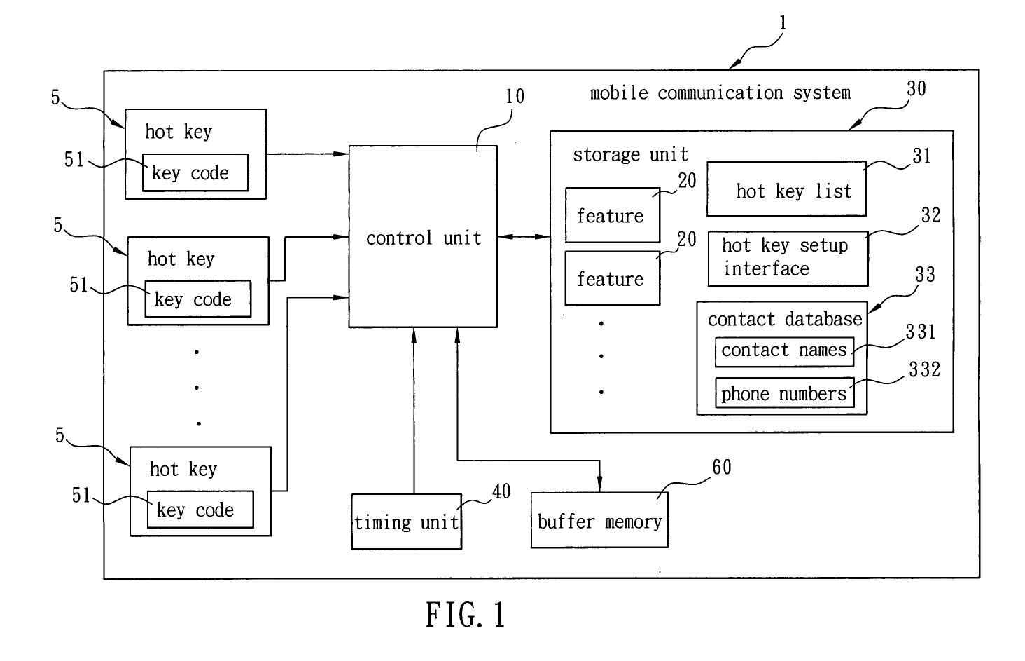

Please refer to FIG. 1 for a first preferred embodiment of the present invention. A mobile communication system 1 (e.g. a cellular phone or a PDA) comprises a control unit 10 (e.g. a central processing unit, CPU), at least one hot key 5, and a plurality of features 20 (special functions). When one of said at least one hot key 5 is triggered, according to the current time, said mobile communication system 1 selectively activates one of said features 20 with respect to the triggered hot key. As a result, the mobile communication system 1 is able to use same hot key(s) 5 to activate different features under different time settings.

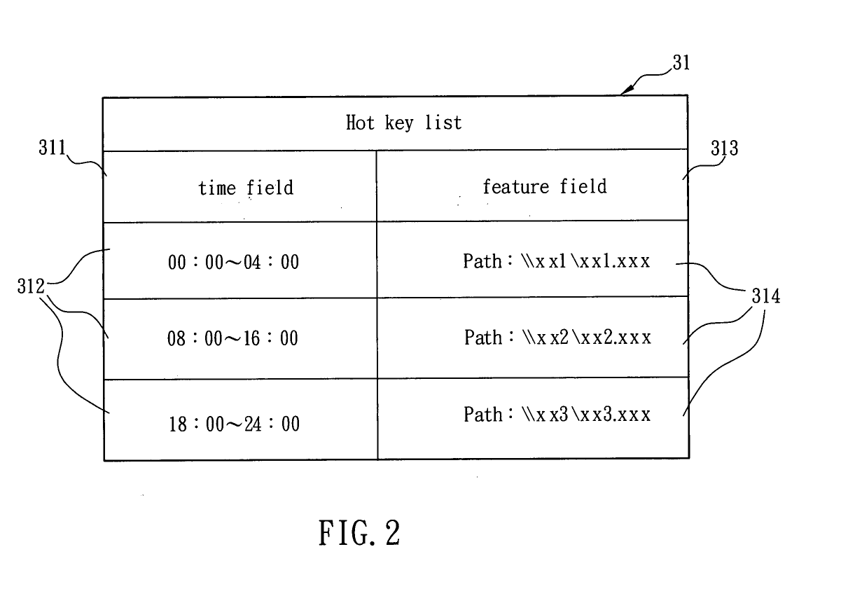

In the first preferred embodiment depicted in FIG. 1 and FIG. 2, said mobile communication system 1 further comprises a storage unit 30, a timing unit 40, and buffer memory 60. Said storage unit 30 comprises a plurality of hot key lists 31 and said features 20 (e.g., gaming function or speed dialing function).

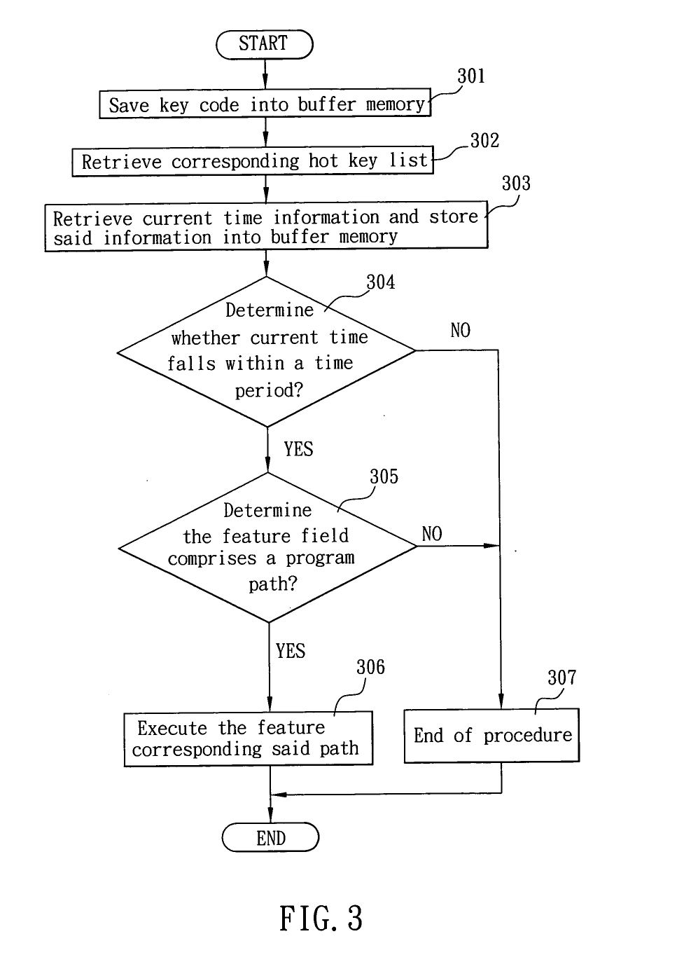

Each of said at least one hot key 5 comprises a corresponding key code 51. Each of said key code 51 corresponds to a hot key list 31. Each of said hot key list 31 comprises a time field 311 and a feature field 313, said time field comprises a time period 312 and said feature field 313 comprises a program path 314 to activate one of said features 20. When a hot key 5 is triggered, its corresponding key code 51 is sent and said control unit 10 executes the procedure described in FIG. 3 as follows.
(301) Receive said key code 51 corresponding to said triggered hot key 5 and save said key code 51 into said buffer memory 60.
(302) According to said key code 51 stored in said buffer memory 60, retrieve a hot key list 31 corresponding to said key code 51.
(303) Retrieve current time information from said timing unit 40 and store said current time information into said buffer memory 60.
(304) Compare said current time information with said time period 312 and determine whether said current time falls within said time period 312; if so, go to step (305), else go to step (307).
(305) Determine whether the feature field 313 corresponding to said time period 312 comprises a program path 314 to a feature 20; if so, go to step (306), else go to step (307).
(306) Execute the feature 20 corresponding to said program path 314.
(307) End of procedure.

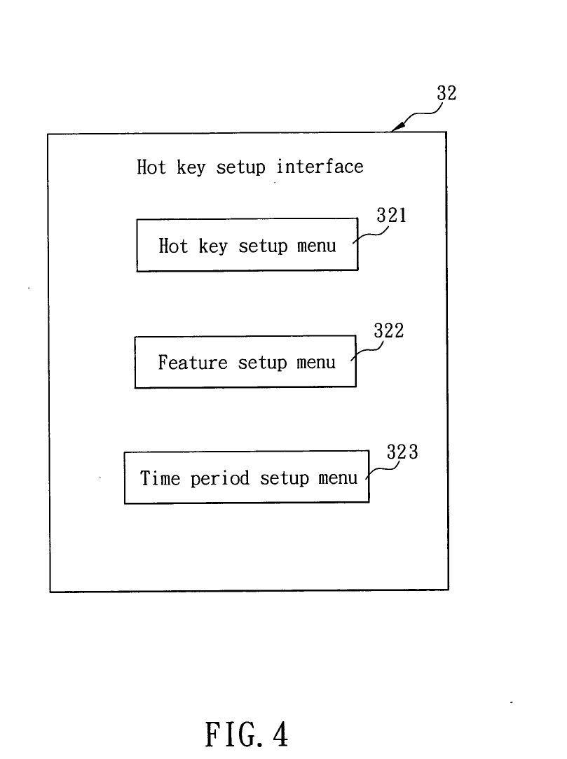

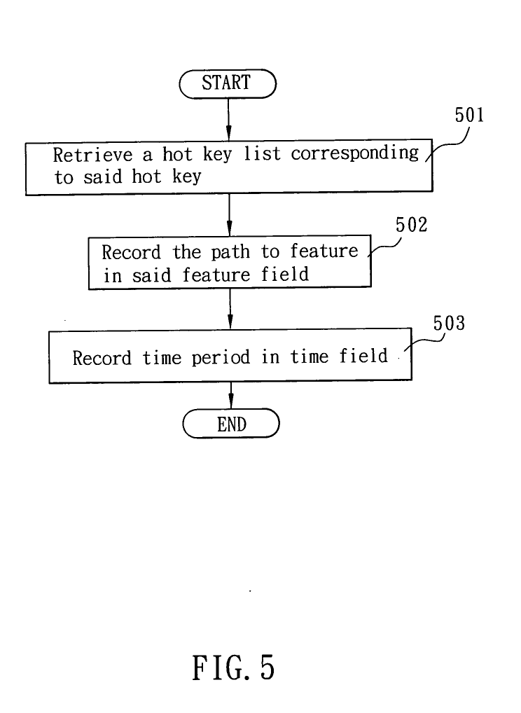

Refer to FIG. 1 and FIG. 4 for said first preferred embodiment. Said storage unit 30 comprises a hot key setup interface 32. Said interface 32 comprises a hot key setup menu 321, a feature setup menu 322 and, a time period setup menu 323. When said interface 32 is completely set up and defined, said control unit 10 performs the procedure described in FIG. 5 as follows.
(501) According to the hot key 5 chosen from said hot key setup menu 321, retrieve a hot key list 31 corresponding to said hot key 5.
(502) According to the feature chosen from said feature setup menu 322, save the path to said feature 20 in said feature field 313.
(503) edit a time period 312 in said time period setup menu 323, and save said time period 312 in a time field 311 corresponding to said feature field 313.

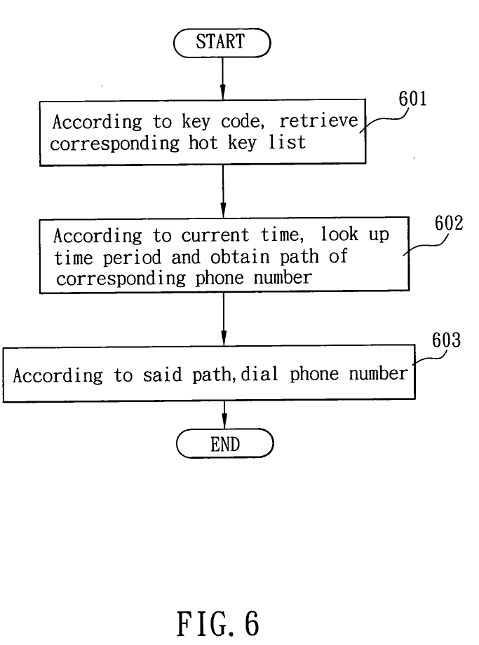

Refer to FIG. 1 for second preferred embodiment of the present invention. Said hot keys 5 can be defined for dialing to a specific receiver, and said feature 20 is a speed dialing function. Said storage unit 30 further comprises a contact database (e.g. an phone book) 33, said contact database 33 comprises a plurality of contact names 331 and phone numbers 332 corresponding to said contact names 331. If a contact name 331 is defined for a hot key 5, the dialing path of the phone number 332 corresponding to said contact name 331 is then defined in said feature field 313 (refer to FIG. 2). As a result, when said hot key 5 is triggered, said control unit 10 performs the procedure described in FIG. 6 as follows.
(601) According to a received key code 51 of said hot key 5, retrieve a hot key list 31 corresponding to said key code 51.
(602) According to current time, look up said time period 312 in said hot key list 31 and obtain the path 314 of the phone number 332 corresponding to said contact name 331.
(603) According to said path 314, dial said phone number 332.

While the invention herein disclosed has been described by means of specific embodiments, numerous modifications and variations could be made thereto by those skilled in the art without departing from the scope and spirit of the invention set forth in the claims.

What is claimed is:

1. A method for activating features in a mobile communication system, said method comprising the steps of:
implementing at least one hot key and a plurality of features;
triggering one or more of said at least one hot key; and
activating one of said features corresponding to the triggered hot key according to the current time.

2. The method of claim 1, wherein said mobile communication system comprises a control unit, a storage unit, and a timing unit; said storage unit comprises at least one hot key list and said plurality of features, each of said at least one hot key corresponds to a key code; each of said key code corresponds to a hot key list; each of said hot key list comprises a time field and a feature field, said time field comprises a time period, said feature field comprises a program path to a feature;
when a hot key is triggered, said control unit performs the steps of:
receiving a key code corresponding to said hot key;
retrieving a hot key list corresponding to said key code;
retrieving current time from said timing unit;
comparing said current time with said time period and determining whether said current time falls within said time period;
if said current time falls within said time period, determining whether the feature field corresponding to said time period comprises a program path; and
if the feature field corresponding to said time period comprises a program path, executing the feature corresponding said path.

3. The method of claim 2, wherein said storage unit further comprises a hot key setup interface, said interface comprises a hot key setup menu, a feature setup menu, and a time period setup menu,
when said interface is completely defined, said control unit performs the steps of:
according to a hot key chosen from said hot key setup menu, retrieving a hot key list corresponding to said hot key;
according to a feature chosen from said feature setup menu, saving the path to said feature in said feature field; and
editing a time period in said time period setup menu, and saving said time period in a time field corresponding to said feature field.

4. An apparatus for activating features in a mobile communication system, said apparatus comprising:
at least one hot key; and
a plurality of features;
wherein when one or more of said at least one hot key is triggered, one of said features corresponding to the triggered hot key is activated according to the current time.
